(19) United States
(12) Patent Application Publication
(10) Pub. No.: US 2026/0341074 A1
(43) Pub. Date: Oct. 29, 2026

(54) Method and System for Authenticating a User Via Touchless Fingerprint Recognition

(71) Applicant: Biocube Technologies Inc., Dover, DE (US)

(72) Inventors: Subodh Narain Agrawal, London (GB); Anil Kumar Sharma, Hillingdon (GB); Ashutosh Agarwal, Gurgaon (IN); Bharat Pruthi, Jind (IN); Sankalp Varshney, Hathras (IN)

(21) Appl. No.: 19/107,919

(22) PCT Filed: Sep. 2, 2023
(86) PCT No.: PCT/IB2023/058697

§ 371 Date: Feb. 28, 2025

(30) Foreign Application Priority Data
Sep. 2, 2022 (IN) 202211050309

(51) Int. Cl. G06V 40/12; G06F 21/32; G06V 10/98; G06V 40/13

(52) U.S. Cl. CPC G06V 40/1365; G06F 21/32; G06V 10/993; G06V 40/1312; G06V 40/1347

(57) ABSTRACT

The present disclosure relates to a method and a system for authenticating a user via touchless fingerprint recognition. The disclosure encompasses: capturing an image of at least a portion of a hand of the user, such that the captured image corresponds to a pre-defined quality parameter; pre-processing the captured image to form a touchless fingerprint image; extracting one or more features from the touchless fingerprint image; comparing the one or more features extracted from the touchless fingerprint image with one or more pre-stored fingerprint image stored in a database; and authenticating the user corresponding to a positive match of the one or more features extracted from the touchless fingerprint image with the features extracted from the pre-stored fingerprint image stored in the database.

### TECHNICAL FIELD

The present disclosure generally relates to a field of 2D touchless fingerprint recognition technology, and more particularly, to a method and a system authenticating a user via touchless fingerprint recognition intelligently wherein capturing schemes operate based on touchless interaction between the user and an image capturing device along with the functionality to run on any edge device.

### BACKGROUND

The following description of related art is intended to provide background Information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Authentication of a user via fingerprint recognition is an automatic process of authentication that involves comparing saved fingerprint patterns in a database with an input fingerprint. This technology can be used in multiple domains wherever identity verification is needed. For example, granting access to a premise, getting customers onboarded through a digital application, and getting users authenticated so they can use services like banking, insurance, visa, etc. The fingerprint recognition can be done by a touch-based fingerprint recognition or a touchless fingerprint recognition.

The existing technology is mostly concentrated on touch-based fingerprint recognition where the system suffers from numerous problems, such as low contrast caused by dirt or humidity on the surface of the capturing device, latent fingerprints of previous users (ghost fingerprints), and/or spread of infection/diseases from one person to another person. Further, the existing technology in the touchless fingerprint recognition certain drawbacks including: less accurate touchless fingerprint recognition for authenticating the user on off-the-shelf mobile devices; and low accuracy of performing a three-level (detection, description, and matching) feature matching process for authentication of the user.

Hence, in view of these and other existing limitations, there arises an imperative need to provide an efficient solution to overcome the above-mentioned limitations. The present invention proposes a novel approach for touchless fingerprint recognition that enhances security, credibility, and provides an efficient and cost-effective solution.

### SUMMARY

This section is provided to introduce certain aspects of the present disclosure in a simplified form that are further described below in the detailed description. This summary is not intended to identify the key features or the scope of the claimed subject matter.

An aspect of the present disclosure relates to a method for authenticating a user via touchless fingerprint recognition. The method encompasses capturing, by an image capturing unit, an image of at least a portion of a hand of the user, such that the captured image of the at least a portion of the hand of the user corresponds to a pre-defined quality parameter. The method further leads to pre-processing the captured image to form a touchless fingerprint image, by a pre-processing module. Further, the method encompasses extracting, by an extraction module, one or more features from the touchless fingerprint image. The method thereafter encompasses comparing, by a comparison module, the one or more features extracted from the touchless fingerprint image with one or more pre-stored fingerprint image stored in a database. And, lastly the method encompasses, authenticating the user corresponding to a positive match of the one or more features extracted from the touchless fingerprint image with the features extracted from the pre-stored image stored in the database by an authentication module.

Another aspect of the present disclosure relates to a contactless fingerprint recognition system for authenticating a user. The contactless fingerprint recognition system includes an image capturing unit adapted to capture an image of at least a portion of a hand of the user, such that the captured image of the at least a portion of the hand of the user corresponds to a pre-defined quality parameter. The contactless fingerprint recognition system includes a pre-processing module adapted to pre-process the captured image to form a touchless fingerprint image. The contactless fingerprint recognition system includes an extraction module adapted to extract one or more features from the touchless fingerprint image. The contactless fingerprint recognition system includes a comparison module adapted to compare the one or more features extracted from the touchless fingerprint image with one or more pre-stored image stored fingerprint image stored in a database. The contactless fingerprint recognition system includes an authentication module adapted to authenticate the user corresponding to a positive match of the one or more features extracted from the touchless fingerprint image with the features extracted from the pre-stored fingerprint image stored in the database.

### BRIEF DESCRIPTION OF THE DRAWINGS

The accompanying drawings, which are incorporated herein, and constitute a part of this disclosure, illustrate exemplary embodiments of the disclosed method. Components in the drawing are not necessarily to scale, emphasis instead being placed upon clearly illustrating the principles of the present disclosure.

FIG. 1 illustrates components of a touchless fingerprint recognition system [100] for authenticating a user.

FIG. 2 illustrates an exemplary method flow diagram [200] for authenticating the user via touchless fingerprint recognition, in accordance with the exemplary embodiment of the present disclosure.

FIG. 3 illustrates an exemplary figure [300] for pre-processing a captured image of at least a portion of a hand for authenticating the user, in accordance with the exemplary embodiment of the present disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skills in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A 6 process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding, data processing, input/output processing, and/or any other functionality that enables the working of the system according to the present disclosure. More specifically, the processor or processing unit is a hardware processor.

As used herein, “a smart electronic device”, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from a processing unit, a storage unit and any other such unit(s) which are required to implement the features of the present disclosure.

As discussed in the background section, there are dire problems with authentication of a user via touch-based fingerprint recognition. Further, the existing technology in the touchless fingerprint recognition certain drawbacks including: less accurate touchless fingerprint recognition for authenticating a user on off-the-shelf mobile devices; and low accuracy of performing a three-level (detection, description, and matching) feature matching process for authentication of the user.

Thus, to overcome the existing problems, a touchless fingerprint recognition system [100] for authenticating the user disclosed herein works efficiently irrespective of the environmental constraints.

Hereinafter, exemplary embodiments of the present disclosure will be described in detail with reference to the accompanying drawings so that those skilled in the art can easily carry out the present disclosure.

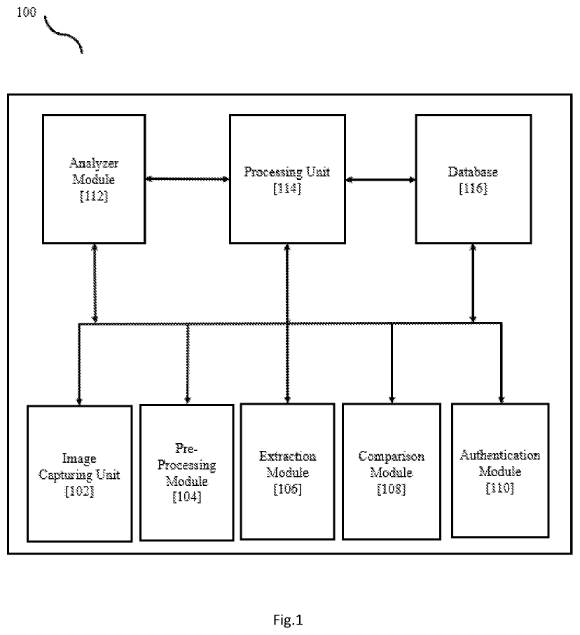

FIG. 1 illustrates components of a touchless fingerprint recognition system [100] for authenticating the user. The touchless fingerprint recognition system comprises: an image capturing unit [102]; a pre-processing module [104]; an extraction module [106]; a comparison module [108]; and an authentication module [110], such that the aforementioned components are connected are in electric communication with each other to authenticate the user via the touchless fingerprint recognition system [100].

### Image Capturing Unit [102]

The image capturing unit [102] of the touchless fingerprint recognition system [100] is adapted to capture an image of at least a portion of a hand of the user. The image capturing unit [102] is selected from a group of a digital camera, a smart-phone camera, handheld scanner type camera, biometric scanning device, and the like. The image capturing unit [102] is configured to auto-capture an image of the at least a portion of the hand of the user, corresponding to a conformation of pre-defined quality parameters, for authentication of the user during the time of authentication. Further, the image capturing unit [102] is also configured to auto-capture an image of the at least a portion of the hand of one or more users, corresponding to a conformation of pre-defined quality parameters, for pre-storing fingerprint images of the one or more users in a database [116]. In an embodiment, the auto-capturing is embedded in an application including, but not limited to, android application, IOS application, and/or computer application. The image capturing unit [102] is further connected to a pre-processing module [104] for pre-processing of a captured image.

### Pre-Processing Module [104]

The pre-processing module [104] is adapted to pre-process the captured image to form a touch-less fingerprint image during the process of authentication of the user. Further, the pre-processing module [104] is also adapted to pre-process the captured image to form a touch-less fingerprint image during the process of pre-storing fingerprint image data of the one or more users. The pre-processing module [104] utilizes an authentication model. The authentication model for pre-processing may include an Artificial Intelligence (Al) based trained model and/or Machine Learning (ML) based trained model. In an embodiment, the authentication mode may be selected from a group including, but not limited to, U-Net, SegNet, PSPNet, DeepLabV3, DeepLabV3+, and/or ResNet50. The pre-processing module [104] is configured to perform a segmentation of hand area within the captured image of the at least a portion of the hand of the user at the time of authentication of the user to only focus on the fingertips by using the authentication model. Further, the pre-processing module [104] is configured to perform a segmentation of hand area within the captured image of the at least a portion of the hand of the one or mor users during pre-storing of the fingerprint image data of the one or more users to only focus on the fingertips by using the aforementioned authentication model. In a preferred embodiment, the DeepLabV3+ model along with ResNet50 as the backbone is utilized to achieve best results. Additionally, the pre-processing module [104] includes the use of Contrast Limited adaptive Histogram equalization (CLAHE) technique in order to enhance the contrast for clearer ridge-line characteristics. The pre-processing module [104] is further connected to the extraction module [106] to extract one or more features of the touchless fingerprint image.

### Extraction Module [106]

The extraction module [106] is configured to extract one or more features of the touchless fingerprint image. Further, the extraction module [106] is also configured to extract one or more features of the pre-stored fingerprint image stored in the database [116] along with the associated pre-stored fingerprint image at the time of registration of the one or more users in the database [116] for the first time. The extracted one or more features are utilized to authenticate the user. The extraction module [106] is further connected to the comparison module [108] for comparison of the one or more features of the touchless fingerprint image with the features extracted from the pre-stored fingerprint images.

### Comparison Module [108]

The comparison module [108] is adapted to compare the one or more features extracted from the touchless fingerprint image of the user with the one or more features extracted from the pre-stored fingerprint image of the one or more users, stored in a database [116], wherein the comparison of the one or more features with the one or more extracted features from pre-stored image is achieved using a Local Feature Transformer (LoFTR) Framework in a preferred and non-limiting embodiment. The LoFTR Framework is adapted to perform a feature matching by performing a pixel-wise dense matching. In an embodiment, the LoFTR Framework makes use of self and cross attention layers that allows the LoFTR Framework to obtain feature descriptors on both the fingerprint image data and touchless fingerprint image. Further, the LoFTR Framework is used for feature matches at coarse level and then refined to acquire accurate matches. Furthermore, LoFTR Framework is also adapted to enable the comparison module [108] to generate pixel-wise dense matches even in case of low-texture areas. The comparison module is further connected to the authentication module [110]. In another embodiment, any specific or generic framework may be used to perform the comparison of the extracted features.

### Authentication Module [110]

The authentication module [110] is adapted to authenticate the user corresponding to a positive match of the one or more features extracted from the touchless fingerprint image with one or more features extracted from the pre-stored fingerprint image stored in the database [116]. The authentication module [110] facilitates the matching of the one or more features extracted from the touchless fingerprint image with one or more features extracted from the pre-stored fingerprint image, which enables the user to verify and authenticate the identity of the user.

### Database [116]

The database [116] is adapted to pre-store the fingerprint image of one or more users to allow the contactless fingerprint recognition system [100] to authenticate the user. The fingerprint image pre-stored in the database [116] further includes associated user data including, but not limited to, name, gender, designation, course details and/or age.

In an embodiment, the contactless fingerprint recognition system [100] for authenticating the user can run on any electronic device including, but not limited to, Smartphone, laptop, computer device, edge device, and/or biometric device.

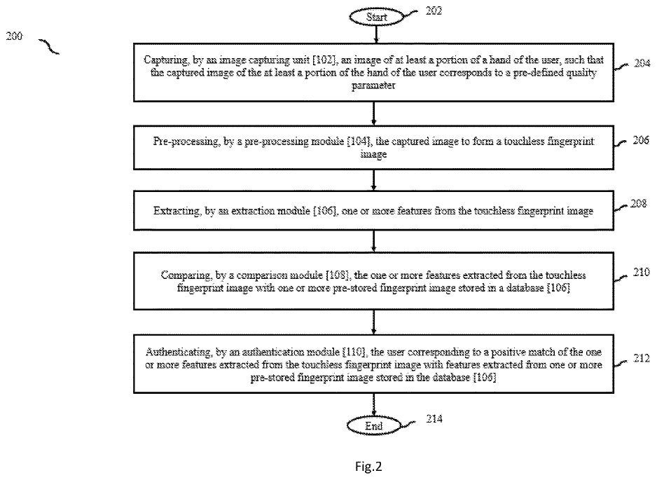

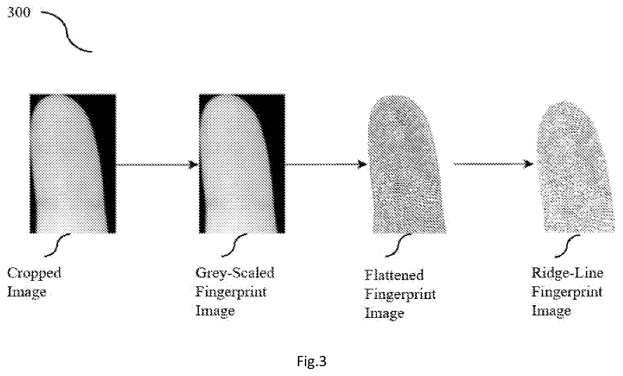

FIG. 2 illustrates an exemplary method flow diagram [200] for authenticating the user via touchless fingerprint recognition, in accordance with the exemplary embodiment of the present disclosure. FIG. 3 illustrates an exemplary figure [300] for pre-processing a captured image of at least a portion of the hand for authenticating the user, in accordance with the exemplary embodiment of the present disclosure. In an implementation the method is performed by the contactless fingerprint recognition system [100]. Further, in an implementation, the system [100] is connected to a user device and in another implementation the system [100] is placed in the user device to implement the features of the present disclosure. Also, as shown in FIG. 3, the method starts at step [202].

At step [204], the method comprises capturing, by an image capturing unit [102], an image of at least a portion of a hand of the user, such that the captured image of the at least a portion of the hand of the user corresponds to a pre-defined quality parameter. The pre-defined quality parameters include: no gap between two corresponding fingers, such that the at least two fingers are stuck to each other; and a straight posture of the hand of the user facing the image capturing unit [102] thereof. The aforementioned pre-defied quality parameters facilitate the extraction of increased number of descriptors compared to the existing solutions, resulting in giving an efficient way of identifying two different fingerprints.

The step of capturing the image includes the steps of:
a) Receiving, by the image capturing unit [102], a set of preview image(s) of the at least a portion of the hand of the user, such that the image capturing unit [102] includes shares auto-focused set of preview image(s) of the at least a portion of the hand of the user are auto-focused with use of an on-device auto capturing;
b) Analyzing, by an analyzer module [112], the set of preview image(s) of the at least a portion of the hand of the user, to check if any of the set of preview image(s) conform to the aforementioned pre-defined quality parameters. In an embodiment, the present invention uses a technique of image augmentation to extract better accuracy results.
c) Identifying, by the analyzer module [112], the any of the set of preview image(s) as the image to be captured, conforming the pre-defined quality parameters. In an embodiment, the pre-defied quality parameters are configured within the touchless fingerprint recognition system [100] using an Oriented FAST and Rotated BRIEF (ORB) image detector, which detects strong corners of an image by comparing them at different scale. In another embodiment, the ORB image detector further includes the usage of FAST or Harris response to detect the best images out of the set of preview image(s).
d) Capturing, by the Optical Imaging Unit [102], the at least a portion of the hand of the user to form a captured image.

In an embodiment of the present invention, the touchless fingerprint recognition method [200] is based on smart devices, where an automated capturing method with integrated focus and quality assessment was used.

Further, at step [206], the method comprises pre-processing, by a pre-processing module [104], the captured image to form a touchless fingerprint image. The pre-processing of the captured image to form a touchless fingerprint image includes the steps of:
1. Cropping, by a Processing unit [114], the captured image to form a colored fingerprint image using an authentication model. The processing unit [114] is adapted to crop the captured image of at least a portion of the hand of the to form a colored fingerprint image using an authentication model. The authentication model is adapted for segmenting at least a portion of the hand of the user to only focus on the fingertips of at least a portion of the hand. The authentication model for pre-processing may include an Artificial Intelligence (Al) based trained model and/or Machine Learning (ML) based trained model. In a non-limiting embodiment, the pre-processing module [104] utilizes an authentication model selected from a group including, but not limited to, U-Net, SegNet, PSPNet, DeepLabV3, DeepLabV3+, and/or ResNet50. Further, after the cropped fingerprint image is obtained from the processing unit, and the cropped fingerprint image is subjected to another process called Normalizing.
a) Normalizing, by the Processing unit [114], the cropped fingerprint image [302] to form a normalized fingerprint image. The processing unit [114] is further adapted to normalize the cropped fingerprint image such that normalizing includes: preparing a grey-scaled fingerprint image from the cropped fingerprint image; preparing a flattened fingerprint image from the grey-scaled fingerprint image; preparing a ridge-line fingerprint image from the flattened fingerprint image; and enhancing the ridge-line fingerprint image to form the touchless finger print image from the ridge-line fingerprint image.

In an embodiment, the aforementioned step of the preparation of the ridge-line fingerprint image includes a contrast-based enhancement of the flattened and gray-scaled fingerprint image, with use of Contrast limited adaptive histogram equalization (CLAHE) technique. The enhanced ridge-line fingerprint image is then processed by the processing unit [114] to form the touchless finger print image.

Next, at step [208] the method comprises extracting, by the extraction module [106], one or more features from the touchless fingerprint image. Extracting the one or more features from the touchless fingerprint image by an extraction module [106] are utilized to authenticate the user. The extraction module [106] is further connected to the comparison module [108] for comparison of the one or more features of the touchless fingerprint image with the features extracted from the pre-stored fingerprint image.

A fingerprint image is formed from an impression of the pattern of ridges on a finger. A ridge is defined as a single curved segment, and a valley is a region between two adjacent ridges. The minutiae, which are the local discontinuities in the ridge flow pattern, provide the features that are used for identification. Details such as the type, orientation, and location of minutiae are considered when performing minutiae extraction. Out of different types of minutiae, there are two most significant minutiae features: one is called ridge ending where the ridge curve terminates, and the other is bifurcation where a ridge splits from a single path to two paths. In an embodiment, the aforementioned features are extracted by the extraction module [106], which are thereby utilized to check the authentication of the user.

Next, at step [210] the method comprises comparing, by a comparison module [108], by using the one or more features extracted from the touchless fingerprint image to compare with one or more features extracted from pre-stored fingerprint image stored in a database [116]. In a non-limiting embodiment, the comparison of the one or more features with the one or more features extracted from the pre-stored image is achieved using a Local Feature Transformer (LoFTR) Framework. The LoFTR Framework is adapted to perform a feature matching by performing a pixel-wise dense matching. In an embodiment, the LoFTR Framework makes use of self and cross attention layers that allows the LoFTR Framework to obtain feature descriptors on both the fingerprint image data and touchless fingerprint image. Further, the LoFTR Framework is used for feature matches at coarse level and then refined to acquire accurate matches. Furthermore, LoFTR Framework is also adapted to enable the comparison module [108]to generate pixel-wise dense matches even in case of low-texture areas. The comparison module is further connected to the authentication module [110].

The process of pre-storage of the fingerprint image data associated with one or more users for the purpose of registration of the one or more users is stored in the database [116] is described herein below:

The above-mentioned steps [204], [206], and [208] are utilized in a similar manner for the purpose of registering the one or more users and storing the fingerprint image data in the database [116]. For this purpose, once the step is performed, a step of storage of the fingerprint image data within the database [116] is performed by the processing unit [118]. The fingerprint image data described herein contains previously stored fingerprint images of the registered one or more users. Further, the extracted one or more features from the cropped fingerprint images of the one or more users are stored in the database [116]. As disclosed above, the fingerprint image data also includes associated user data including, but not limited to, name, gender, designation, course details and/or age.

Next, at step [212] the method comprises authentication, by the authentication module [110], the user corresponding to a positive match of the one or more features extracted from the touchless fingerprint image with the one or more features extracted from the pre-stored fingerprint image stored in the database [106]. In an embodiment, a negative match of the one or more features extracted from the touchless fingerprint image with the one or more features extracted from the pre-stored fingerprint image stored in the database [106] leads to rejection of the authentication of the user. The identity of the user is confirmed from, whether a positive match of the one or more features extracted from the touchless fingerprint image corresponds to the one or more features extracted from the pre-stored fingerprint image stored in the database [116]. In an embodiment of the present disclosure, the authentication process to conclude if the touchless fingerprint image and any one of the finger print image data are matching or not, Scale Invariant Feature Transform (SIFT) and/or Siamese Network can be used. In an embodiment, the aforementioned positive matching of the one or more features extracted from the touchless fingerprint image with the one or more features extracted from pre-stored fingerprint image stored in the database [106] allows the user to access wherever the touchless fingerprint recognition system [100] is deployed.

In an embodiment, each of the Image Capturing Unit [102], Pre-Processing Module [104], the Extraction Module [106], the Comparison Module [108], the Authentication Module [110], the Analyzer Module [112], and the Database [116] are connected to the Processing Unit [114] such that the Processing Unit [114] enables of the aforementioned components to perform their designated functions as disclosed in the present disclosure.

In an exemplary embodiment, as per the present disclosure, I^{A} donates a pre-stored finger image of a user A in the database [116], and I^{B} donates a touchless fingerprint image of the user A which shall be used for the purpose of authentication of the user A. At the time of registration of the fingerprint, one or more features of the fingerprint image of the I^{A} is stored in the database [116]. In an embodiment, the registration can be done by registering the touchless impression of at least a portion of a hand of the user in a database. In another embodiment, the registration can be done by registering the touch-based impression of at least a portion of a hand of the user in a database. The image I^{A} goes through the steps of capturing, pre-processing, and extracting of the features, before getting encoded and stored in the database [116]. In similar context, the image I^{B}, which is the input image at the time of authentication, goes through the process of capturing, pre-processing, extracting of one or more features from the touchless fingerprint image, and comparing. Lastly, when the system performs coarse-level feature transformation, both the I^{A} and I^{B} fingerprints are sent to the comparison module [108] for comparing the one or more extracted features of I^{A} and I^{B}. In case of a positive matching of the one or more features of I^{A} and I^{B} by the comparison module [108], the authenticating module [110] authenticates the user A. But, in case of a negative matching of the one or more features of I_{A} and I^{B} by the comparison module [108], the authenticating module [110] rejects the authentication of the user A.

As evident from the above disclosure, the present invention also provides following advantages:
a. Chances of spreading of any infections/disease because of the use of touchless fingerprint recognition system [100] is minimal.
b. The present invention of the touchless fingerprint recognition system [110] works efficiently irrespective of environmental constraints.
c. The framework used in the present invention gives better and more accurate matching of the one or more features by the use of LoFTR Framework, as per the present disclosure, and thereby reducing the number of false positive and false negative results.
d. Superior replacement for passwords and identity cards as fingerprints are much harder to fake, and they change very little over a lifetime, so the data remains updated and more accurate than passwords and photos.
e. Touchless fingerprint recognition is a cost-effective secure solution as small hand-held scanners are easy to set up and deliver a high level of accuracy too.

While considerable emphasis has been placed on the disclosed embodiments, it will be appreciated that many embodiments can be made and that many changes can be made to the embodiments without departing from the principles of the present disclosure. These and other changes in the embodiments of the present disclosure will be apparent to those skilled in the art, whereby it is to be understood that the foregoing descriptive matter to be implemented is illustrative and non-limiting.

I/We claim:

1. A method [200] for authenticating a user via contactless fingerprint recognition, the method [200] comprising:
capturing, by an image capturing unit [102], an image of at least a portion of a hand of the user, such that the captured image of the at least a portion of the hand of the user corresponds to a pre-defined quality parameter;
pre-processing, by a pre-processing module [104], the captured image to form a touchless fingerprint image;
extracting, by an extraction module [106], one or more features from the touchless fingerprint image;
comparing, by a comparison module [108], the one or more features extracted from the touchless fingerprint image with one or more pre-stored fingerprint image stored in a database [106]; and
authenticating, an authentication module [110], the user corresponding to a positive match of the one or more features extracted from the touchless fingerprint image with the features extracted from the pre-stored fingerprint image stored in the database [106].

2. The method [200] as claimed in claim 1, wherein the step of capturing the image of the at least a portion of the hand of the user comprises:
receiving, by the image capturing unit [102], a set of preview image(s) of the at least a portion of the hand of the user;
analyzing, by an analyser module [112], the set of preview image(s) of the at least a portion of the hand of the user, to check if any of the set of preview image(s) conform to the pre-defined quality parameters,
identifying, by the analyser module [112], the any of the set of preview image(s) as the image to be captured, conforming the pre-defined quality parameters;
capturing, by the Optical Imaging Unit [102], the at least a portion of the hand of the user.

3. The method [200] as claimed in claim 2, wherein the pre-defined quality parameters include: no gap between two corresponding fingers; and a straight posture of the hand of the user, Palmar side facing the image capturing unit [102] thereof.

4. The method [200] as claimed in claim 1, wherein the step of pre-processing the captured image of at least one finger comprises:
cropping, by the Processing Unit [104], the captured image to form a coloured fingerprint image using an authentication model;
normalizing, by the Processing Unit [104], the cropped fingerprint image to form a normalized fingerprint image, such that normalizing includes:
preparing a grey-scaled fingerprint image from the cropped fingerprint image;
preparing a flattened fingerprint image from the grey-scaled fingerprint image; and
preparing a ridge-line fingerprint image from the flattened fingerprint image;
enhancing the ridge-line fingerprint image, to form the touchless finger print image from the ridge-line fingerprint image.

5. The method [200] as claimed in claim 4, wherein the authentication model for pre-processing may include an Artificial Intelligence (Al) based trained model and/or Machine Learning (ML) based trained model.

6. The method [200] as claimed in claim 4, wherein the step of preparation of the ridge-line fingerprint image includes a contrast-based enhancement of the flattened fingerprint image, with use of at least one noise amplification reduction technique.

7. The method [200] as claimed in claim 1, wherein pre-stored fingerprint image stored in a database [106], pertains to a plurality of fingerprint image from a plurality of authenticated users, such that each of plurality of fingerprint image of each of the authenticated users comprises one or more pre-stored features.

8. The method [200] as claimed in claim 1, wherein the comparison is performed by use of a pixel-wise dense matching of the features.

9. A contactless fingerprint recognition system [100] for authenticating a user, the contactless fingerprint recognition system [100] comprising:
an image capturing unit [102] adapted to capture an image of at least a portion of a hand of the user, such that the captured image of the at least a portion of the hand of the user corresponds to a pre-defined quality parameter;
a pre-processing module [104] adapted to pre-process the captured image to form a touchless fingerprint image;
an extraction module [106] adapted to extract one or more features from the touchless fingerprint image;
a comparison module [108] adapted to compare the one or more features extracted from the touchless fingerprint image with one or more pre-stored image stored fingerprint image stored in a database; and
an authentication module [110] adapted to authenticate the user corresponding to a positive match of the one or more features extracted from the touchless fingerprint image with the features extracted from the pre-stored fingerprint image stored in the database [106].

10. The system [100] as claimed in claim 9, wherein the system [100] for authenticating the user may run on an electronic device including, but not limited to, smartphone, laptop, computer device with integrated megapixel camera, and biometric device.
